(19) United States
(12) Patent Application Publication
(10) Pub. No.: US 2017/0147950 A1
(43) Pub. Date: May 25, 2017

(54) DYNAMICALLY DELAYING RESERVATIONS FOR LIMITED RESOURCES USING COURTESY SCORES

(71) Applicant: International Business Machines Corporation, Armonk, NY (US)

(72) Inventors: Lee A. Carbonell, Flower Mound, TX (US); Tsz S. Cheng, Grand Prairie, TX (US); Jeffrey L. Edgington, Keller, TX (US); Pandian Mariadoss, Allen, TX (US)

(21) Appl. No.: 14/945,645

(22) Filed: Nov. 19, 2015

(51) Int. Cl. G06Q 10/02; G06Q 10/10

(52) U.S. Cl. CPC G06Q 10/02; G06Q 10/1095

(57) ABSTRACT

Managing reservations for limited resources such as meeting rooms within a network computing system may include, responsive to receiving a reservation for a meeting room from a requestor, determining, using a processor, availability of meeting rooms for the reservation and determining, using the processor, eligibility of the requestor according to a courtesy score for the requestor. The courtesy score may be determined according to historical usage of the meeting rooms by the requestor. The reservation may be selectively confirmed according to the courtesy score and the availability of the meeting rooms. Further, a particular meeting room may be assigned to the reservation subsequent to the confirming.

### BACKGROUND

This disclosure relates to reserving limited resources and dynamically delaying reservations for the limited resources using courtesy scores. Within a typical work environment, many resources are limited in nature. Meeting rooms are one example of a limited resource. Depending on the availability, usage demand, and usage patterns, finding and reserving a meeting room may be challenging. Moreover, the scarcity of meeting rooms may lead to frustration among users particularly when these resources are not utilized to their full potential.

In some cases, for example, meeting rooms may not actually be used for the dates and times reserved (e.g., a “no show” situation). Other times, the reservation for the meeting room may have been canceled, but not in a timely manner so that the meeting room may be made available to another. In other cases, meeting rooms may be reserved for more time than is actually needed or ultimately used leaving the meeting rooms underutilized. In still other cases, meeting rooms of larger capacity than needed may be reserved, thereby rendering the meeting rooms unavailable to others that may need the larger capacity meeting rooms.

### SUMMARY

An embodiment of the present invention may include a method of managing reservations for limited resources such as meeting rooms within a network computing system. The method may include, responsive to receiving a reservation for a meeting room from a requestor, determining, using a processor, availability of the meeting rooms for the reservation and determining, using the processor, eligibility of the requestor according to a courtesy score for the requestor. The courtesy score may be determined according to historical usage of the meeting rooms by the requestor. The reservation may be selectively confirmed according to the courtesy score and the availability of the meeting rooms. Further, a particular meeting room may be assigned to the reservation subsequent to the confirming.

Another embodiment of the present invention may include a system for managing reservations for limited resources such as meeting rooms. The system may include a processor programmed to initiate executable operations as described herein.

Another embodiment of the present invention may include a computer program including a computer readable storage medium having program code stored thereon. The program code may be executable by a processor to perform a method of managing reservations for limited resources such as meeting rooms as described herein.

This Summary section is provided merely to introduce certain concepts and not to identify any key or essential features of the claimed subject matter. Other features of the inventive arrangements will be apparent from the accompanying drawings and from the following detailed description.

### BRIEF DESCRIPTION OF THE DRAWINGS

The inventive arrangements are illustrated by way of example in the accompanying drawings. The drawings, however, should not be construed to be limiting of the inventive arrangements to only the particular implementations shown. Various aspects and advantages will become apparent upon review of the following detailed description and upon reference to the drawings.

FIG. 1 is a block diagram illustrating an example of a network computing system.

FIG. 2 is an exemplary software architecture for the reservation system of FIG. 1.

FIG. 3 is a flow chart illustrating an exemplary method of managing reservations for a limited resource.

FIG. 4 is a block diagram illustrating an exemplary architecture for a data processing system for use with the inventive arrangements described herein.

### DETAILED DESCRIPTION

This disclosure relates to reserving limited resources and dynamically delaying reservations for the limited resources using courtesy scores. In accordance with the inventive arrangements disclosed herein, a reservation for a limited resource such as a meeting room may be received by a system. The system may determine a variety of factors such as availability of the limited resources and a courtesy score for the requestor. The courtesy score, in general, is an indication of the usage behavior of the limited resources by the requestor. The system may utilize the courtesy score, among other factors, for determining how to handle the reservation.

In some cases, for example, the system may not confirm the reservation immediately. For example, the system may dynamically delay confirmation of the reservation according, at least in part, to the courtesy score of the requestor by first adding the reservation to a waiting list. The reservation may be confirmed at a later time based upon a priority of the reservation, as may be determined using the courtesy score, and/or the availability of the limited resources. In other cases, the system may confirm the reservation and delay the assignment of a particular limited resource to the reservation until a later time. As such, though the reservation is confirmed, designation of a particular limited resource in fulfillment of the reservation may not be performed until a later date and/or time closer to the date of the reservation.

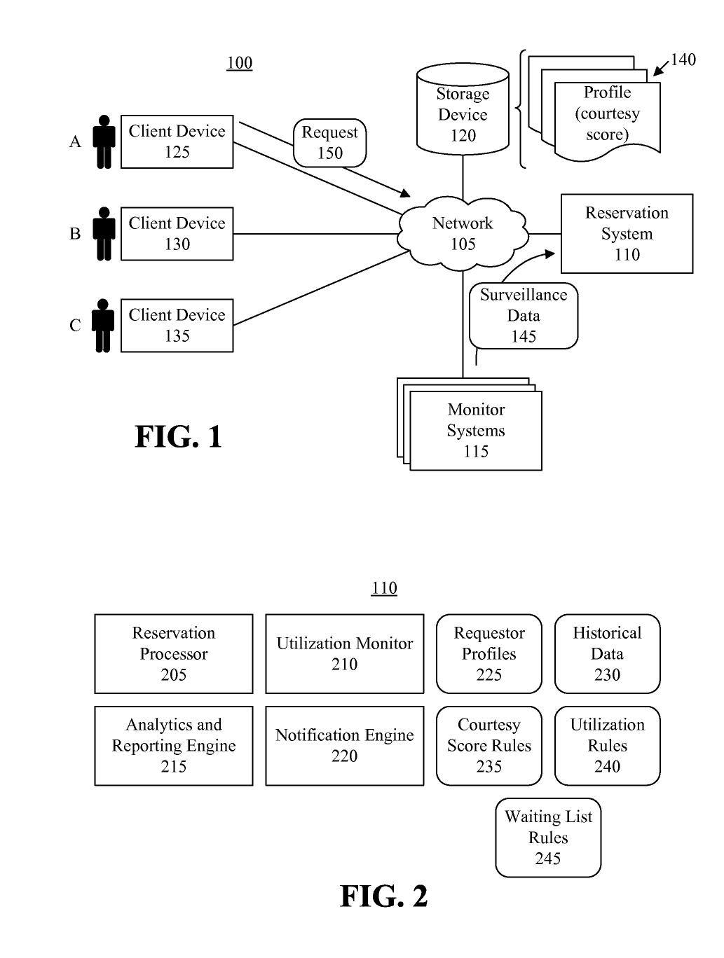

FIG. 1 is a block diagram illustrating an example of a network computing system 100 in which the inventive arrangements may be implemented. Network computing system 100 contains a network 105. Network 105 is the medium used to provide communications links between various devices and data processing systems connected together within network computing system 100. Network 105 may include connections, such as wire, wireless communication links, or fiber optic cables. Network 105 may be implemented as, or include, any of a variety of different communication technologies such as a Wide Area Network (WAN), a Local Area Network (LAN), a wireless network, a mobile or cellular network, a Virtual Private Network (VPN), the Internet, the Public Switched Telephone Network (PSTN), or the like.

In the depicted example, a reservation system 110 and one or more monitor systems 115 may couple to network 105 along with a storage device 120. In addition, client devices (clients) 125, 130, and 135 may couple to network 105. Clients 125, 130, and 135 may be, for example, personal computers, portable devices, network computers, tablet computers, mobile phones, or the like. Reservation system 110 may be implemented as one or more data processing systems, e.g., servers, executing suitable operational software to support accepting reservations, confirming reservations, and/or performing other operations related to making reservations as described herein for clients 125, 130, and 135. Clients 125, 130, and 135 may communicate with reservation system 110 in order to make reservations for limited resources managed through reservation system 110.

In one arrangement, storage device 120 may store profiles 140 for requestors. In the example of FIG. 1, the requestors may be users A, B, and C. Each profile 140 may include a courtesy score for the user associated therewith. The courtesy score, which may be calculated by reservation system 110, may be determined, at least in part, based upon the historical usage of the limited resources managed by reservation system 110 by the user.

For purposes of illustration, the limited resource may be meeting rooms. Accordingly, user A, B, and/or C may make reservations for meeting rooms using clients 125, 130, and 135, respectively. Though reservation system 110 is described herein with respect to managing reservations for meeting rooms, it should be appreciated that reservation system 110 may be used to manage reservations for other limited resources such as bandwidth, vehicle rentals, or the like.

Monitor systems 115 may monitor usage of the meeting rooms to determine any of a variety of different usage factors including, but not limited to, whether the limited resource was actually used during the reserved time, whether the limited resource was appropriately utilized, e.g., fully utilized, and the like. The information determined by monitor systems 115 may be provided to reservation system 110 as surveillance data 145. Monitor systems 115 may include, but are not limited to, card entry systems for meeting rooms; audio, visual, and/or audio visual surveillance systems; biometric sensor systems such as retinal scanning systems, fingerprint scanning systems; keypad entry systems; badge reader systems; and the like that may be used to determine occupancy of a meeting room, entry of users into meeting rooms, and/or exit of users from meeting rooms. Data collected by monitor systems 115 may be collectively referred to as surveillance data 145.

Reservation system 110 may process surveillance data 145 to calculate courtesy scores on a per requestor basis. As defined within this specification, a “requestor” means the entity on behalf of whom a user sends a request for a reservation. The requestor may be the user that sends the request, or may be a group including a plurality of users. The user may be part of the group such as a member of the group or an assistant that handles reservations on behalf of the group. For example, a requestor may be a development group, a work group, or the like. The user making the request may be a group leader or an assistant for the group.

In one embodiment, user A of client device 125 may send a request 150 to reservation system 110. User A, in this example, is a requestor. Request 150 may specify a reservation for a limited resource managed by reservation system 110. As noted, for purposes of illustration, the limited resources managed by reservation system 110 may be meeting rooms. Reservation system 110 may accept the reservation specified by request 150, may queue the reservation, may confirm the reservation, may delay confirming the reservation, and/or may assign a particular limited resource, e.g., a particular meeting room to the reservation once confirmed as described within this specification. In general, reservation system 110 utilizes the courtesy score of the requestor to determine, at least in part, how to handle the reservation specified by request 150.

FIG. 1 is provided for purposes of illustration and is not intended to limit the inventive arrangements described herein. It should be appreciated that network computing system 100 may include fewer elements than shown or more elements such as additional servers, clients, and other devices.

FIG. 2 is an exemplary software architecture for reservation system 110 of FIG. 1. As pictured, reservation system 110 may include a reservation processor 205, a utilization monitor 210, an analytics and reporting engine 215, and a notification engine 220. Reservation system 110 may also include a variety of data repositories storing data such as requestor profiles 225, historical data 230, courtesy score rules 235, utilization rules 240, and waiting list rules 245.

Reservation processor 205 may be configured to maintain and/or track an inventory of meeting rooms including meeting room status and/or scheduling. Reservation processor 205 may track attributes of meeting rooms. Examples of attributes for meeting rooms that may be tracked by reservation processor 205 may include, but are not limited to, location, capacity, size, floor plan, and/or assets/services available with the meeting room. Reservation processor 205 further may perform operations such as determining and/or tracking reservation status such as “received,” “waiting list,” “confirmed,” “assigned,” “canceled.” Reservation processor 205 may also be configured to determine whether and/or when to calculate (e.g., also update) courtesy scores and to calculate courtesy scores in accordance with the various rules described herein.

Utilization monitor 210 may be configured to determine usage of meeting rooms from processing received surveillance data 145. In general, utilization monitor 210 may process received surveillance data 145 from one or more monitor systems and determine usage information that may be stored as, or as part of, historical data 230. From surveillance data 145, for example, utilization monitor 210 may determine check-ins to meeting rooms, check-outs from meeting rooms, and determine meeting room usage from video analytics, audio analytics, and the like for purposes validating meeting room utilization.

In one arrangement, utilization monitor 210 may continually receive utilization data 245 from one or more monitor systems as described. Utilization monitor 210 may determine whether a meeting room was fully utilized for the entire duration of the reservation. For example, utilization monitor 210, using surveillance data 145, may determine whether occupants arrived on time for the meeting, left during the meeting, whether one or more occupants did not show up at all for a meeting, etc. Utilization monitor 210 may generate a count of the occupants throughout the duration of the reservation. Utilization monitor 210, for example, may process surveillance data in the form of video, audio, and/or audiovisual data obtained from in-room sensors to detect human forms from images and/or video and/or to detect human voices and/or other noise in a meeting room during a meeting (e.g., a confirmed reservation for which a particular meeting room has been assigned). In another example, utilization monitor 210 may determine whether certain attributes, e.g., a projector, of the limited resource were utilized since that particular meeting room may have been assigned due to a reservation requirement of having a projector.

Analytics and reporting engine 215 may be configured to perform requestor reporting, group reporting, forecasting of future needs or growth in support of real estate planning, and the like. For example, analytics and reporting engine 215 may determine the effects of meeting room usage and/or patterns on performance of groups, e.g., teams and/or organizations. In one aspect, analytics and reporting engine 215 may access one or more data repositories such as historical data 230, requestor profiles 225, and the like to determine patterns and trends in the data. For example, analytics and reporting engine 215 may use historical data 230 to forecast future need or growth based on reservation data contained therein. In another example, analytics and reporting engine 215 may use historical data 230 to determine the effect of meeting room usage on employee or project productivity. Analytics and reporting engine 215, for example, may determine whether a correlation exists between desired usage patterns of meeting rooms with productivity (e.g., goal achievement) of a particular group.

Notification engine 220 may be configured to send notifications. Notification engine 205 may send the notifications using any of a variety of different communication channels, whether through a social networking system (e.g., an organization specific social networking system), an instant messaging system, and electronic mail system, or the like.

In one aspect, notification engine 220 may send notifications for reservation status changes. For example, as a reservation moves through various status changes such as accepted, confirmed, waiting list, room assigned, etc., notification engine 220 may send updates to the requestor and/or any attendees that wish to be notified. In one arrangement, notification engine 220 may differentiate between attendees that are occupants and those that are not. Notification engine 220, for example, may send updates only to those attendees that are occupants.

Notification engine 220 further may send reports as may be generated by analytics and reporting engine 215. For example, notification engine 220 may send quarterly reports, monthly reports, etc., on meeting room utilization to administrators. Administrators may adjust rules responsive to the received reports. The reports may also be sent to site planners for planning purposes relating to whether fewer or more meeting rooms may be required.

In another arrangement, notification engine 220 may send reports based upon a requestor's courtesy score. For example, notification engine 220 may send a notification to a particular requestor responsive to an event such as the courtesy score of the requestor falling below a threshold, being lowered, rising above a threshold, being increased, or the like. Notification engine 220 may also send usage history reports to individual requestors from time-to-time, periodically, or responsive to a request.

Requestor profiles 225 may include requestor preferences, requestor courtesy scores, and/or requestor historical data relating to reservation system 110. As noted, a requestor may be an individual user or a group of users (e.g., a team of users and/or users assigned to a particular project). Accordingly, a group may have a requestor profile having a group courtesy score that may be adjusted as described herein. In the case where a group has an assistant, when the assistant creates submits a reservation on another user's behalf, e.g., for the group, the requestor profiles and courtesy score specified therein may be for the group including the assistant. The courtesy score is not assigned to the assistant as an individual, but rather to the group for which the meeting is requested. Historical data 230 may include room request history, room utilization history, and the like.

Courtesy score rules 235 may include rules that determine how the courtesy score is calculated in response to particular events. For example, courtesy score rules 235 may specify how the courtesy score of a requestor is adjusted responsive to a cancellation in view of the timing of the cancellation with respect to the date of the reservation. Courtesy score rules 235 may also specify how utilization of meeting rooms may be used to adjust courtesy scores. For example, the courtesy score rules 235 may specify whether the courtesy score of a user is to be increased/decreased and by how much based upon the time the meeting room was used in comparison to the amount of time the meeting room was booked, the number of persons utilizing the meeting room during the time that the meeting room was booked compared to the capacity of the meeting room, and the like. The courtesy score rules 235 may further specify how modifications to the reservation relating to time and capacity may be used to adjust the courtesy score of a requestor.

Utilization rules 240 may specify eligibility criteria for room confirmation; timing, delay, and/or scheduling for meeting room assignment; prioritization rules for confirmation and/or meeting room assignment; optimization rules for meeting room assignment; and/or meeting room utilization criteria on a per-meeting room basis. The timing, delay, and/or scheduling rules may indicate, for example, the amount of time prior to a requested meeting date and/or time that particular operations such as cancellation are to be performed.

Courtesy score rules 235 and/or utilization rules 240 may be edited by an administrator based upon requirements of a particular organization. The administrator may increase or decrease the adjustment to courtesy rules for the various types of factors discussed in courtesy score rules 235. Further, the administrator may add one or more other events and corresponding adjustments to courtesy scores rules 235 as may be required based upon particular meeting room usage patterns and behaviors that an organization seeks to encourage and discourage. An administrator may adjust eligibility criteria for room confirmation; timing, delay, and/or scheduling for meeting room assignment; prioritization rules for confirmation and/or meeting room assignment; optimization rules for meeting room assignment and the like of utilization rules 240 in accordance with observed meeting room usage patterns in an organization and/or desired meeting room behaviors of the organization. In general, courtesy score rules 235 and/or utilization rules 240 may be adjusted to encourage desired meeting room reservation behaviors and discourage undesired meeting room reservation behaviors.

Waiting list rules 245 may specify eligibility criteria for waiting list placement, waiting list prioritization rules; delay and/or timing rules for room confirmation, and the like. The delay and/or timing rules may specify the amount of time prior to a requested meeting date and/or time that an operation such as confirming a reservation is to occur.

The architecture described with reference to FIG. 2 is provided for purposes of illustration only. Reservation processor 205, utilization monitory 210, analytics and reporting engine 215, and notification engine 220 may be implemented as executable program code stored in a memory of reservation system 110 and executed. Requestor profiles 225, historical data 230, courtesy score rules 235, utilization rules 240, and waiting list rules 245 may be stored in a data storage device of reservation system 110 and/or within another data storage device accessible to reservation system 110 such as storage device 120.

In one exemplary embodiment, reservation processor 205 may update courtesy scores of requestors based upon historical data 230, courtesy score rules 235, and utilization rules 240. As an illustrative example, reservation processor 205 may determine, from historical data 230 generated at least in part by utilization monitor 210, that a meeting room was used for the duration of the reservation and had the number of occupants for the duration of the meeting as specified by the reservation. In that case, reservation processor 205 may increase the courtesy score of the requestor for the meeting.

In general, reservation processor 205 may increase courtesy scores responsive to desirable meeting room usage behavior and decrease courtesy scores responsive to undesirable meeting room usage behavior. The particular amount of increase and/or decrease and circumstances for increasing and/or decreasing a courtesy score may be specified as one or more rules within courtesy score rules 235 as previously described.

The following examples, if detected by reservation processor 205, may result in reservation processor 205 increasing a courtesy score.
Proper utilization of a meeting room, i.e., utilization that matches the reservation as to duration, number of occupants, and the like, may result in reservation processor 205 increasing the courtesy score of the requestor.
Cancelling or modifying a reservation within an amount of time specified by a courtesy score rule in advance of the meeting date and/or time.
Using a properly-sized room as determined from the number of occupants of the meeting specified by the reservation, as validated by utilization monitor 210, and the maximum occupancy of the meeting room.

The following examples, if detected by reservation processor 205, may result in reservation processor 205 decreasing a courtesy score.
Canceling a reservation after the start of a meeting.
Canceling a reservation in an amount of time prior to the meeting that is less than the amount specified in courtesy score rules 235, e.g., less than an hour prior to the start of the meeting.
Not using the meeting room during the reservation time as may be determined by utilization monitor 210.
Creating a repeating reservation for a meeting room and not using the meeting room as scheduled as determined by utilization monitor 210.

Requestors, whether individual users or groups of users, may be prioritized according to their courtesy scores by the system. In other cases, further rules may be specified as courtesy score rules 235 and/or utilization rules 240 that may be used to override situations for critical groups, projects, and/or users. For example, rules may specify overrides for particular users and/or groups according to the role of the user(s) in the organization. As another example, if a high level executive is on site, a rule may be created that causes reservation processor 205 to calculate the courtesy score for the executive as the highest possible, regardless of the executive's actual meeting room usage behavior. In another example, the rule may indicate that courtesy score is to be ignored completely and to use only meeting room availability for confirming and/or assigning meeting rooms to reservations.

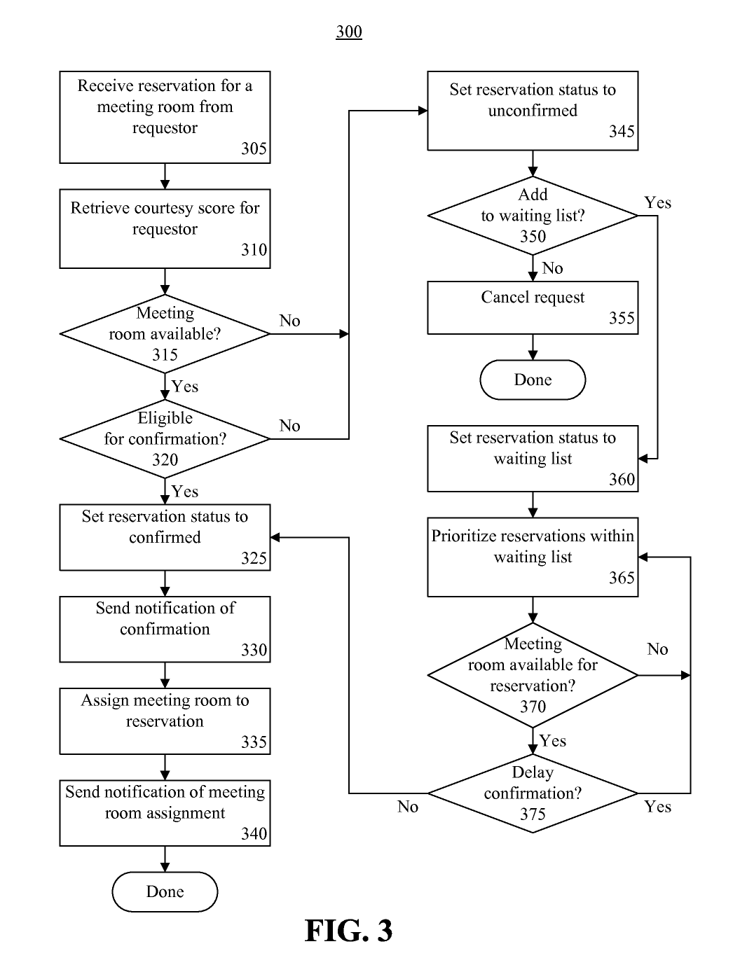

FIG. 3 is a flow chart illustrating an exemplary method 300 of managing reservations for a limited resource. As discussed, an example of a limited resource may be meeting rooms. In one arrangement, method 300 may be performed by reservation system 110 (hereafter “the system”) of FIGS. 1 and 2 described herein.

In block 305, the system may receive a reservation for a meeting room from a requestor. In one aspect, the status of a reservation received from a requestor may be initially set to “accepted”. The reservation may include, or specify, the date the meeting room is needed, a time that the meeting room is needed, and a duration that the meeting room is needed. The reservation may also specify participants of the meeting to take place, a number of occupants for the meeting room, and/or other requirements for the meeting room such as projectors, food catering, and the like. In another arrangement, the request may also indicate whether the reservation is recurring. The term “occupant,” as defined herein, means a user that is expected to be physically present within the meeting room for the time specified in the reservation. A meeting may include further users that participate via teleconference and/or videoconference. Such users, however, are not considered occupants. Occupants are participants.

For example, the requestor may log into the system using his or her client. The requestor has a requestor profile that may be located responsive to logging into the system. The requestor profile specifies a courtesy score for the requestor. If the requestor does not have an account, the requestor may create an account. The system may then create a requestor profile, calculate a courtesy score per the rules, and store the courtesy score within the requestor profile.

In block 310, the system may retrieve the courtesy score for the requestor. The system may retrieve the requestor profile for the requestor and retrieve the courtesy score stored therein. In general, the system may utilize the courtesy score to determine the priority that the requestor will have over other requestors. The system may use the courtesy score to resolve conflicting requests for reservations for meeting rooms.

In block 315, the system may determine whether any meeting rooms are available. If so, method 300 may continue to block 320. If not, method 300 may continue to block 345. For example, the system may determine whether any meeting rooms, with attributes, match the parameters specified in the reservation. Meeting rooms with attributes matching parameters in the reservation if not already assigned to a reservation are considered available for purposes of the request.

Proceeding to block 320 in the case where a meeting room is available, the system may determine whether the requestor is eligible for confirmation. If so, method 300 may continue to block 325. If not, method 300 may continue to block 345. In one arrangement, the system may determine whether a requestor is eligible for confirmation according to the courtesy score of the requestor. For example, the system may compare the courtesy score of the requestor with a threshold. When the courtesy score is higher than the threshold, the system determines that the requestor is eligible for confirmation. When the courtesy score is not higher than the threshold, the system determines that the requestor is not eligible for confirmation. In one aspect, the threshold may be specified within the utilization rules described with reference to FIG. 2.

Continuing with block 325, the system sets the reservation status to confirmed. As defined within this disclosure, the term “confirmed,” as applied to the status of the reservation, means that a meeting room is available to fulfill the reservation. A reservation and/or request with a confirmed status is not yet assigned a specific meeting room. In block 330, the system may send a notification of the confirmed status to the requestor. The notification indicates that a meeting room is available to fulfill the reservation. As noted, the particular meeting room is not yet assigned to the reservation. In the case of confirmed meeting room, e.g., responsive to the notification, the requestor's calendar application may show the meeting on the user's calendar despite a particular meeting room not yet being assigned to the reservation. A particular meeting room may later be assigned per utilization rules 240.

In block 335, the system may assign a particular meeting room to the reservation. In one arrangement, the assignment of a specific meeting room to the reservation may be performed immediately following setting the status of the reservation to confirmed. In another arrangement, the assignment of a specific meeting room to the reservation may be delayed or performed at a subsequent time. The system may assign a specific meeting room to the reservation based upon a determination of which meeting room (e.g., the attributes thereof) most closely matches the parameters specified by the reservation.

In terms of delaying assignment of a specific meeting room to the reservation, the system may wait until a predetermined amount of time prior to the date and/or time of the reservation before assigning a particular meeting room to the reservation. As an illustrative example, consider the case where a requestor submits a reservation for a meeting room for a date that is one week into the future. In this example, if a meeting room is available and the courtesy score of the requestor is above the threshold, the system may set the reservation status to confirmed. The system may wait for one or more days before assigning a particular meeting room to the reservation. For example the system may wait until 1, 2, 3, or more days prior to the date and/or time of the reservation before assigning a particular meeting room to the reservation.

By waiting, the system may be better able to balance requests with the inventory of meeting rooms. The system may receive a reservation for a meeting room for 3 occupants for a meeting that is to occur one week after the reservation is submitted. Two days after receiving the reservation, the system may receive another reservation for a meeting room for a meeting to include 7 occupants and occurring on the same date and/or time of the prior reservation. The system may determine that 2 meeting rooms are available. The meeting rooms may be a 4-person meeting room and an 8-person meeting room. By waiting until a day or more before the actual date and/or time of the meeting, the system may assign the 4-person meeting room to the request for a meeting room for 3 occupants; and, assign the 8-person meeting room to the request for a meeting room for 7 occupants. Had the reservations been assigned meeting rooms immediately upon receipt, the larger meeting room may have been assigned to the request for a meeting room for 3 occupants, thereby leaving no available meeting rooms for the second, larger meeting.

In block 340, the system may send a notification of the meeting room assignment. For example, the system may set the status of the reservation to “meeting room assigned” and send the notification indicating the status change. The system may send notification to the requestor specifying the particular meeting room that has been assigned to the reservation. In another arrangement, the system may also send a notification to each participant and/or each occupant of the meeting. For example, the reservation initially submitted by the requestor may specify a list of participants and/or occupants for the meeting. In that case, the system may send notifications informing each such user of the particular meeting room that has been assigned to the reservation. Further, the calendar entry on each participant and/or occupant may be updated to include the particular meeting room assigned.

Continuing with block 345, in the case where there are no meeting rooms available or the courtesy score of the requestor does not exceed the threshold, the system may set the reservation status to unconfirmed. An unconfirmed reservation status means that the system queues the reservation at least temporarily. Accordingly, in block 350, the system may query the requestor whether he or she would like to be added to the waiting list. The system may receive a response back from the requestor indicating yes to being added to the waiting list or no. If the requestor agrees to be added to the waiting list, method 300 may continue to block 360. If the requestor does not agree to be added to the waiting list, method 300 may continue to block 355. In block 355, the system may cancel the reservation from the requestor. In that case, no further action is taken by the system for reservation.

In block 360, the system may set the reservation status to “waiting list.” Each reservation having a status of “waiting list” is queued and may be considered on the waiting list used by system. In block 365, the system may prioritize reservations on the waiting list. The system may prioritize reservations according to the courtesy score of the requestor that submitted each reservation. One arrangement, reservations may be sorted or prioritized from highest courtesy score to lowest courtesy score so that reservations with higher courtesy scores are given priority within the waiting list and considered by the system prior to those reservations with lower courtesy scores.

In block 370, the system may determine whether any meeting rooms are available. As discussed, the system may determine whether any meeting rooms having attributes that meet the parameters of the reservations on the waiting list are available. The comparison may be performed so that reservations with higher courtesy scores are considered prior to reservations with lower courtesy scores. Still, the system may compare attributes of an available meeting room with parameters of a reservation on the waiting list to determine a match. In one aspect, the system may determine that a meeting is available if at least one assignment plan of meeting rooms to reservations, as determined by the system where attributes of meeting rooms match and/or correspond to parameters of reservations, exists that satisfies both the existing commitments (i.e., confirmed and/or assigned reservations) and the reservation from the waiting list under consideration. Responsive to determining that no meeting rooms are available, method 300 may loop back to block 365 to continue processing. Responsive to determining that at least one meeting room is available for a reservation on the waiting list, method 300 may proceed to block 375.

In block 375, the system may determine whether to delay confirmation for the reservation of a request identified in block 370. If the system determines the confirmation is to be delayed, method 300 may loop back to block 365 to continue processing. If the system determines that the confirmation is not to be delayed, method 300 may continue to block 325 to continue processing.

In the case where the system determines to further delay confirmation for the reservation, method 300 may loop back to block 365 as noted. As such, the request remains on the waiting list. In one arrangement, the system may determine how long the confirmation is to be delayed based upon a comparison of the courtesy score associated with the request and one or more rules of waiting list rules 245. For example, waiting list rules 245 may specify conditions and priority, e.g., a courtesy score threshold and timing and/or time that a reservation should be placed on the waiting list. Waiting list rules 245 may also specify the time period for the delay, e.g., 24 hours before the requested meeting start time, before a reservation is confirmed, but not yet assigned. In this manner, the confirmation of the reservation may be delayed dynamically in that the amount of delay may be determined in real time according to the value of the courtesy score of the requestor and the particular rules in effect at the time of evaluation.

While on the waiting list, each reservation, including any reservation previously identified in block 370, may be prioritized according to the courtesy score associated with the request. The prioritization performed by the system is performed with respect to any new reservations added to the waiting list and any other reservations that may have been removed from the waiting list. As such, a determination that confirmation is to be delayed for a particular request may result in that request remaining on the waiting list for one or more subsequent iterations through block 370 without being selected.

In accordance with the inventive arrangements described herein, in some cases, when a requestor submits a reservation for a meeting room at the last minute and no meeting rooms are available, the system, in applying the rules described herein, may not be able to confirm a meeting room for the reservation. In such cases, the reservation may be canceled. As an alternative, the rules may be updated, as described, with exceptions for particular requestors (e.g., individual users and/or groups) to accommodate a particular need for a meeting room.

In the case where the system determines not to delay or further delay confirmation, method 300, as noted proceeds to block 325 where the reservation status is set to confirmed. Further processing of the reservation may continue as previously described with reference to block 330, 335, and 340. Appreciably, when meeting room is determined to be available for a request on the waiting list in block 370 and confirmation is not delayed, the request is removed from the waiting list. The system may assign a meeting room to the reservation, at least in part, according to utilization rules 240. Utilization rules 240, for example, may specify priority, optimization, eligibility, and the like of how meeting rooms are assigned to reservations in order to match the reservations and the time period to wait before meeting room assignment is to be performed, e.g., 12 hours before meeting start time.

In one aspect, the reservation processor may continuously update the notification engine with meeting room availability and reservation status. As such, the notification engine may notify the appropriate users, e.g., requestor, participants, and/or occupants, of any status updates for the reservation in accordance with any preferences specified in a requestor profile. As noted, the notification engine may update meeting invites with newly available information such as status changes and/or meeting room assignments.

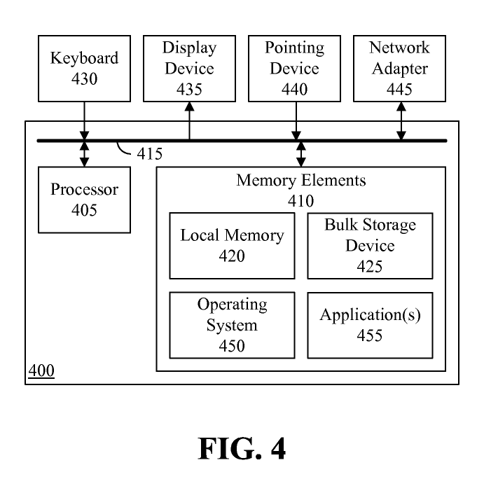

FIG. 4 is a block diagram illustrating an exemplary architecture 400 for a data processing system. Architecture 400 may be used to implement a computer that is suitable for storing and/or executing program code. In one aspect, for example, architecture 400 may be used to implement reservation system 110 of FIG. 1.

Architecture 400 includes at least one processor 405, e.g., a central processing unit (CPU), coupled to memory elements 410 through a system bus 415 or other suitable circuitry. Architecture 400 stores program code within memory elements 410. Processor 405 executes the program code accessed from memory elements 410 via system bus 415. In one aspect, architecture 400 may be used to implement a computer or other data processing system that is suitable for storing and/or executing program code. It should be appreciated, however, that architecture 400 may be used to implement any system including a processor and memory that is capable of performing the operations described within this disclosure.

Memory elements 410 include one or more physical memory devices such as, for example, a local memory 420 and one or more bulk storage devices 425. Local memory 420 may be implemented as a random access memory (RAM) or other non-persistent memory device(s) generally used during actual execution of the program code. Bulk storage device 445 may be implemented as a hard disk drive (HDD), solid state drive (SSD), or other persistent data storage device. Architecture 400 also may include one or more cache memories (not shown) that provide temporary storage of at least some program code in order to reduce the number of times program code must be retrieved from the bulk storage device during execution.

Input/output (I/O) devices such as a keyboard 430, a display device 435, and a pointing device 440 optionally may be coupled to architecture 400. The I/O devices may be coupled to architecture 400 either directly or through intervening I/O controllers. A network adapter 445 may also be coupled to architecture 400 to enable a system implemented using architecture 400 to become coupled to other systems, computer systems, remote printers, and/or remote storage devices through intervening private or public networks. Modems, cable modems, Ethernet cards, and wireless transceivers are examples of different types of network adapter 445 that may be used with architecture 400.

Memory elements 410 store an operating system 450 and an application 455. Operating system and application 455, being implemented in the form of executable program code, are executed by architecture 400. As such, operating system 450 and/or application 455 may be considered an integrated part of any system implemented using architecture 400. Application 455 and any data items used, generated, and/or operated upon by architecture 400 while executing application 455 are functional data structures that impart functionality when employed as part of architecture 400. As used to implement messaging system 110 of FIG. 1, operating system 450 may be a server-side operating system; and, application 455 may be a server-side application that, when executed, causes the server to perform the various operations described herein.

While the disclosure concludes with claims defining novel features, it is believed that the various features described herein will be better understood from a consideration of the description in conjunction with the drawings. The process(es), machine(s), manufacture(s) and any variations thereof described within this disclosure are provided for purposes of illustration. Any specific structural and functional details described are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

For purposes of simplicity and clarity of illustration, elements shown in the figures have not necessarily been drawn to scale. For example, the dimensions of some of the elements may be exaggerated relative to other elements for clarity. Further, where considered appropriate, reference numbers are repeated among the figures to indicate corresponding, analogous, or like features.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting. Notwithstanding, several definitions that apply throughout this document now will be presented.

As defined herein, the singular forms “a,” “an,” and “the” are intended to include the plural forms as well, unless the context clearly indicates otherwise.

As defined herein, the term “another” means at least a second or more.

As defined herein, the terms “at least one,” “one or more,” and “and/or,” are open-ended expressions that are both conjunctive and disjunctive in operation unless explicitly stated otherwise. For example, each of the expressions “at least one of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

As defined herein, the term “automatically” means without user intervention.

As defined herein, the term “coupled” means connected, whether directly without any intervening elements or indirectly with one or more intervening elements, unless otherwise indicated. Two elements may be coupled mechanically, electrically, or communicatively linked through a communication channel, pathway, network, or system.

As defined herein, the term “executable operation” or “operation” is a task performed by a data processing system or a processor within a data processing system unless the context indicates otherwise. Examples of executable operations include, but are not limited to, “processing,” “computing,” “calculating,” “determining,” “displaying,” “comparing,” or the like. In this regard, operations refer to actions and/or processes of the data processing system, e.g., a computer system, or similar electronic computing device, that manipulates and transforms data represented as physical (electronic) quantities within the computer system's registers and/or memories into other data similarly represented as physical quantities within the computer system memories and/or registers or other such information storage, transmission or display devices.

As defined herein, the terms “includes,” “including,” “comprises,” and/or “comprising,” specify the presence of stated features, integers, steps, operations, elements, and/or components, but do not preclude the presence or addition of one or more other features, integers, steps, operations, elements, components, and/or groups thereof.

As defined herein, the term “if” means “when” or “upon” or “in response to” or “responsive to,” depending upon the context. Thus, the phrase “if it is determined” or “if [a stated condition or event] is detected” may be construed to mean “upon determining” or “in response to determining” or “upon detecting [the stated condition or event]” or “in response to detecting [the stated condition or event]” or “responsive to detecting [the stated condition or event]” depending on the context.

As defined herein, the terms “one embodiment,” “an embodiment,” or similar language mean that a particular feature, structure, or characteristic described in connection with the embodiment is included in at least one embodiment described within this disclosure. Thus, appearances of the phrases “in one embodiment,” “in an embodiment,” and similar language throughout this disclosure may, but do not necessarily, all refer to the same embodiment.

As defined herein, the term “output” means storing in physical memory elements, e.g., devices, writing to display or other peripheral output device, sending or transmitting to another system, exporting, or the like.

As defined herein, the term “plurality” means two or more than two.

As defined herein, the term “processor” means at least one hardware circuit configured to carry out instructions contained in program code. The hardware circuit may be an integrated circuit. Examples of a processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller.

As defined herein, the terms “program code,” “software,” “application,” and “executable code” mean any expression, in any language, code or notation, of a set of instructions intended to cause a data processing system to perform a particular function either directly or after either or both of the following: a) conversion to another language, code, or notation; b) reproduction in a different material form. Examples of program code may include, but are not limited to, a subroutine, a function, a procedure, an object method, an object implementation, an executable application, an applet, a servlet, source code, object code, a shared library/dynamic load library and/or other sequence of instructions designed for execution on a computer system.

As defined herein, the term “real time” means a level of processing responsiveness that a user or system senses as sufficiently immediate for a particular process or determination to be made, or that enables the processor to keep up with some external process.

As defined herein, the term “responsive to” means responding or reacting readily to an action or event. Thus, if a second action is performed “responsive to” a first action, there is a causal relationship between an occurrence of the first action and an occurrence of the second action. The term “responsive to” indicates the causal relationship.

As defined herein, the term “user” means a human being.

The terms first, second, etc. may be used herein to describe various elements. These elements should not be limited by these terms, as these terms are only used to distinguish one element from another unless stated otherwise or the context clearly indicates otherwise.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method of managing reservations for meeting rooms within a network computing system, comprising:
responsive to receiving a reservation for a meeting room from a requestor, determining, using a processor, availability of the meeting rooms for the reservation;
determining, using the processor, eligibility of the requestor according to a courtesy score for the requestor, wherein the courtesy score is determined according to historical usage of the meeting rooms by the requestor;
selectively confirming, using the processor, the reservation according to the courtesy score and the availability of the meeting rooms; and
assigning, using the processor, a particular meeting room to the reservation subsequent to the confirming.

2. The method of claim 1, further comprising:
responsive to determining that the meeting rooms for the reservation are not available or that the courtesy score is below a threshold, adding the reservation to a waiting list.

3. The method of claim 2, further comprising:
prioritizing, according to courtesy scores, the reservation among other reservations on the waiting list; and
confirming the reservation responsive to determining that a meeting room is available and that confirmation for the reservation is not to be delayed using the courtesy score.

4. The method of claim 1, wherein the particular meeting room is not assigned to the reservation until a predetermined amount of time prior to a date of the reservation.

5. The method of claim 1, further comprising:
responsive to receiving the reservation, retrieving the courtesy score for the requestor from a data storage device.

6. The method of claim 1, further comprising:
adjusting the courtesy score according to historical usage of the meeting rooms by the requestor.

7. The method of claim 1, further comprising:
sending a notification indicating confirmation of the reservation to the requestor; and
sending a further notification indicating assignment of the particular meeting room to the reservation.

8. A system for managing reservations for meeting rooms, comprising:
a processor programmed to initiate executable operations comprising:
responsive to receiving a reservation for a meeting room from a requestor, determining availability of the meeting rooms for the reservation;
determining eligibility of the requestor according to a courtesy score for the requestor, wherein the courtesy score is determined according to historical usage of the meeting rooms by the requestor;
selectively confirming the reservation according to the courtesy score and the availability of the meeting rooms; and
assigning a particular meeting room to the reservation subsequent to the confirming.

9. The system of claim 8, wherein the processor is further programmed to initiate executable operations comprising:
responsive to determining that the meeting rooms for the reservation are not available or that the courtesy score is below a threshold, adding the reservation to a waiting list.

10. The system of claim 9, wherein the processor is further programmed to initiate executable operations comprising:
prioritizing, according to courtesy scores, the reservation among other reservations on the waiting list; and
confirming the reservation responsive to determining that a meeting room is available and that confirmation for the reservation is not to be delayed using the courtesy score.

11. The system of claim 8, wherein the particular meeting room is not assigned to the reservation until a predetermined amount of time prior to a date of the reservation.

12. The system of claim 8, wherein the processor is further programmed to initiate executable operations comprising:
responsive to receiving the reservation, retrieving the courtesy score for the requestor from a data storage device.

13. The system of claim 8, wherein the processor is further programmed to initiate executable operations comprising:
adjusting the courtesy score according to historical usage of the meeting rooms by the requestor.

14. The system of claim 8, wherein the processor is further programmed to initiate executable operations comprising:
sending a notification indicating confirmation of the reservation to the requestor; and
sending a further notification indicating assignment of the particular meeting room to the reservation.

15. A computer program product comprising a computer readable storage medium having program code stored thereon, the program code executable by a processor to perform a method of managing meeting rooms, comprising:
responsive to receiving a reservation for a meeting room from a requestor, determining, using a processor, availability of the meeting rooms for the reservation;
determining, using the processor, eligibility of the requestor according to a courtesy score for the requestor, wherein the courtesy score is determined according to historical usage of the meeting rooms by the requestor;
selectively confirming, using the processor, the reservation according to the courtesy score and the availability of the meeting rooms; and
assigning, using the processor, a particular meeting room to the reservation subsequent to the confirming.

16. The computer program product of claim 15, further comprising:
responsive to determining that the meeting rooms for the reservation are not available or that the courtesy score is below a threshold, adding the reservation to a waiting list.

17. The computer program product of claim 16, further comprising:
prioritizing, according to courtesy scores, the reservation among other reservations on the waiting list; and
confirming the reservation responsive to determining that a meeting room is available and that confirmation for the reservation is not to be delayed using the courtesy score.

18. The computer program product of claim 15, wherein the particular meeting room is not assigned to the reservation until a predetermined amount of time prior to a date of the reservation.

19. The computer program product of claim 15, further comprising:
responsive to the request, retrieving the courtesy score for the requestor from a data storage device.

20. The computer program product of claim 15, further comprising:
adjusting the courtesy score according to historical usage of the meeting rooms by the requestor.
